(19) United States
(12) Patent Application Publication
(10) Pub. No.: US 2014/0372181 A1
(43) Pub. Date: Dec. 18, 2014

(54) DEVICE FOR DETERMINING CONFIGURATION OF BUSINESS UNITS AND METHOD FOR DETERMINING CONFIGURATION OF BUSINESS UNITS

(71) Applicant: Hitachi, Ltd., Tokyo (JP)

(72) Inventor: Junko Hosoda, Tokyo (JP)

(21) Appl. No.: 14/365,296

(22) PCT Filed: Dec. 17, 2012
(86) PCT No.: PCT/JP2012/082602

§ 371 Date: Jun. 13, 2014

(30) Foreign Application Priority Data
Feb. 21, 2012 (JP) 2012-034633

(51) Int. Cl. G06Q 10/06

(52) U.S. Cl. CPC G06Q 10/0637
USPC 705/7.36

(57) ABSTRACT

The present invention determines a configuration of sites that enables low-cost operation under normal circumstances, and maintains the stockout rate of end products at an appropriate value when trouble occurs. A device for determining the configuration of sites, comprising: a storage unit for storing information about sites, including information about the names and classification of the sites, transportation information including information pertaining to supply routes between the sites, cost information including the cost generated by the manufacture and procurement of products and commodity items, and trouble probability information including the probability of trouble occurring at the sites; and a stockout rate and cost evaluation unit for calculating the stockout rate and cost of the end products by setting the lowermost stream of the information about the sites as the starting point and creating a plurality of combinations for the configuration of the sites while varying the allocation ratios of the supply routes included in the transportation information, setting a commodity item in the site constituting the uppermost stream in the information about the sites as a starting point for each of the resulting combinations for the configuration of the sites and tracing end users in accordance with the supply routes included in the transportation information, calculating the stockout rate of each of the commodity items for each of the sites from the trouble probability information, calculating the cost of each of the commodity items for each of the sites from the cost information, and accumulating the results.

### TECHNICAL FIELD

The present invention relates to a device for determining the configuration of sites.

### BACKGROUND ART

As a background art of the present technical field, there is JP-A-2009-129092 (Patent Literature 1). In this publication, there is a description that “to supply articles from respective article suppliers when there are a plurality article suppliers for performing optimum stock management causing no shortage or excessive stock of the articles” (refer to the abstract).

### CITATION LIST

### Patent Literature

Patent Literature 1: JP-A-2009-129092

### SUMMARY OF INVENTION

### Technical Problem

In the Patent Literature 1, a scheme of the stock management is described which does not cause the stockout nor excessive stock of the procured articles. However, according to the scheme of the stock management of the Patent Literature 1, plural suppliers with different procurement lead time are necessary for preventing the stockout of the article of the object. Because the articles come to be purchased also from suppliers of high unit purchase price of articles in order to increase the number of the suppliers, the purchase cost of the articles increases. Further, prevention of the stockout of each of the articles is the object, and there is no mention on the stockout of the end product manufactured by combining the articles. As a result, there is a possibility that total supply chain excessively provides against the stockout of the end products and excessive cost is generated.

Therefore, the object is to determine the configuration of sites that enables low-cost operation under normal circumstances and maintains the stockout rate of end products at an appropriate value when trouble occurs.

### Solution to Problem

In order to solve the problem, for example, configurations described in claims are employed. Although the present application includes plural solutions for solving the problem, one example thereof is a site allocation determining device producing the stockout rate and cost of end products by accumulating the stockout rate and cost of commodity items for upstream sites in each of the sites on a distribution network, including: a storage unit for storing demand information including demand quantity, product configuration information expressing the relation between master commodity items and slave commodity items constituting products, site information including names and classification information of the sites, transportation information including information pertaining to transportation routes between the sites, cost information including the cost generated by procurement and manufacture of products and commodity items, and trouble probability information including probability of trouble occurring at each of the sites; and a stockout rate and cost evaluation unit for calculating the stockout rate and cost of the end products by setting the lowermost stream of the site information as a starting point and creating a plurality of combinations for the configuration of the sites while varying the allocation ratio of the supply routes included in the transportation information, setting a commodity item in the site constituting the uppermost stream in the site information as a starting point for each of created combinations for the configuration of the sites and tracing end users in accordance with the supply routes included in the transportation information, calculating the stockout rate of each of the commodity items for each of the sites from the trouble probability information, calculating the cost of each of the commodity items for each of the sites from the cost information, and accumulating the results.

### Advantageous Effects of Invention

According to the present invention, a configuration of sites that enables suppression of the cost under normal circumstances and appropriate suppression of the stockout rate of the end products even when trouble occurs can be determined.

### BRIEF DESCRIPTION OF DRAWINGS

FIG. 1 is an example of the block diagram of a site allocation determining device of the example 1.

FIG. 2 is a hardware configuration example of the site allocation determining device of the example 1.

FIG. 3 is an example of the site allocation determining process flow of the example 1.

FIG. 4 is an example of the demand information.

FIG. 5 is an example of the product configuration information.

FIG. 6 is an example of the site information.

FIG. 7 is an example of the distribution information.

FIG. 8 is an example of the supplier cost information.

FIG. 9 is an example of the trouble probability information.

FIG. 10 is an example of the display result selection standard information.

FIG. 11 is an example of the all combination creating process flow for the site allocation.

FIG. 12 is an example of the site allocation combination creating process flow of the suppliers.

FIG. 13 is an example of the site allocation combination information.

FIG. 14 is an example of the stockout rate calculating process flow of the end product.

FIG. 15 is an example of the stockout rate calculating process flow of the end user.

FIG. 16 is an example of the stockout rate/cost information of the sites/commodity item.

FIG. 17 is an example of the cost calculating process flow.

FIG. 18 is an example of the stockout rate/cost information of the commodity item/site.

FIG. 19 is an example of the stockout rate/cost information of the end product.

FIG. 20 is an example of the display result information.

FIG. 21 is an example of the stockout rate/cost display screen.

FIG. 22 is an example of the result detail screen.

FIG. 23 is an example of the block diagram of a site allocation determining device of the example 2.

FIG. 24 is an example of the site information of the example 2.

FIG. 25 is an example of the site information after inputting the trouble probability of the example 2.

FIG. 26 is an example of the trouble probability information of the example 2.

### DESCRIPTION OF EMBODIMENTS

Below, examples will be described using drawings.

### EXAMPLE 1

In the present example, with respect to plural site allocations, the end product stockout rate when trouble occurs and the cost under normal circumstances are evaluated and are comparatively displayed.

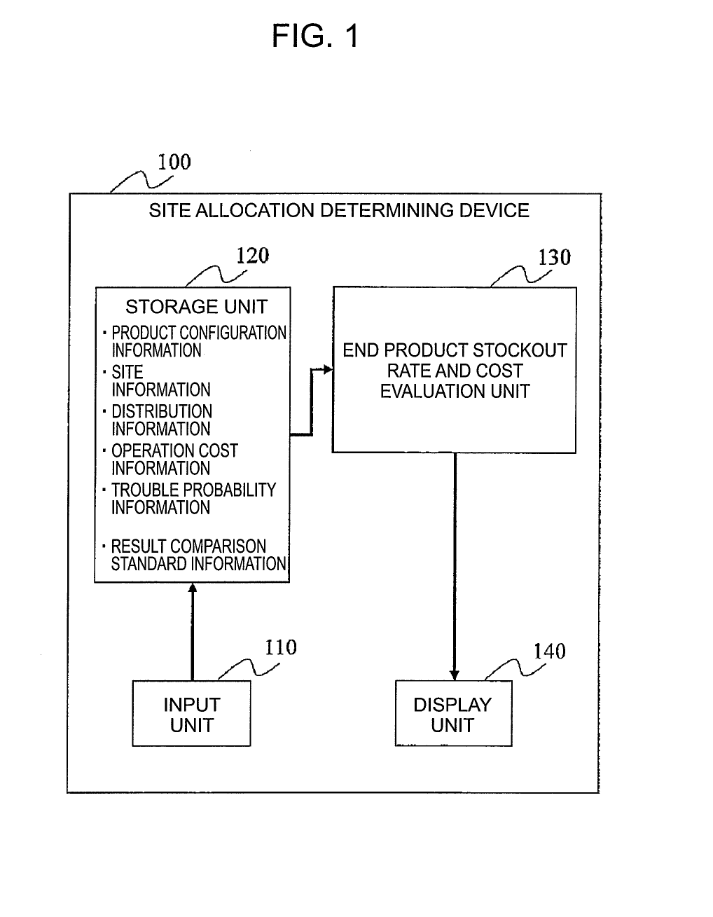

FIG. 1 is an example of the block diagram showing the function configuration of a site allocation determining device of the present example. The site allocation determining device 100 includes an input unit 110, a storage unit 120, an end product stockout rate and cost evaluation unit 130, and a display unit 140.

The input unit 110 reads the demand information, product configuration information, site information, distribution information, operation cost information, trouble probability information, and result comparison standard information which are the external data, and stores the same in the storage unit 120.

The storage unit 120 stores the demand information, product configuration information, site information, supplier information, distribution information, cost information, trouble probability information, and result comparison standard information which are the external data.

The end product stockout rate and cost evaluation unit 130 uses the product configuration information, site information, supplier information, distribution information, cost information, trouble probability information, and result comparison standard information stored in the storage unit, and determines one or more site allocations for which the result is comparatively displayed.

The display unit 140 is a user interface for displaying various operation screens, images and the like according to the instruction of other function units.

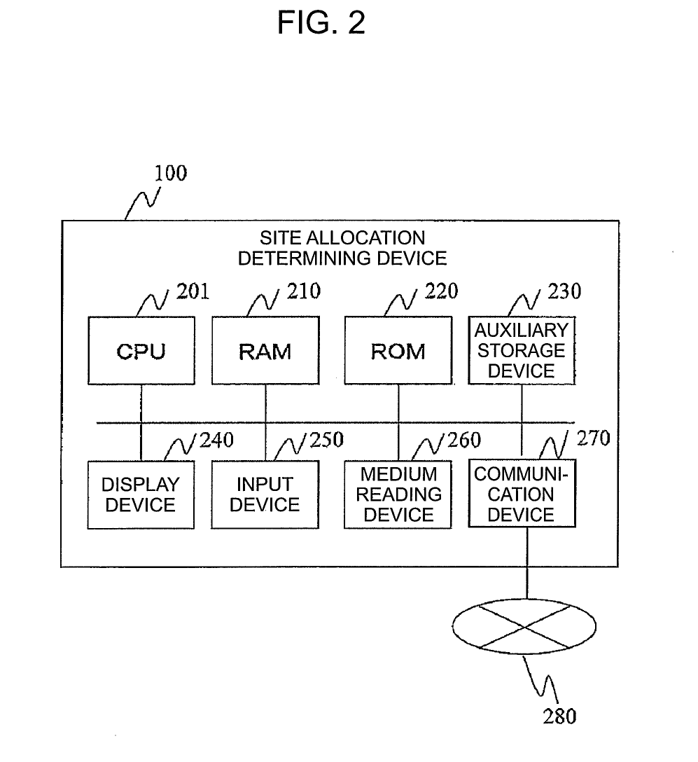

FIG. 2 is a block diagram showing a hardware configuration example of the site allocation determining device 100 of the present example. The site allocation determining device 100 includes a CPU 201, a RAM 210, a ROM 220, an auxiliary storage device 230, a display device 240, an input device 250, a medium reading device 260, and a communication device 270.

The CPU 201 is a unit that executes various calculations. The CPU 201 executes various processes by executing a predetermined site allocation determination program (not illustrated) loaded on the RAM 210 from the auxiliary storage device 230.

The site allocation determination program is an application program executable on an OS (Operation System) program for example. The site allocation determination program may be installed in the auxiliary storage device 230 from a portable storage medium through the medium reading device 260 for example.

The RAM 210 is a memory that stores a program executed by the CPU 201, data required for executing the program, and the like. The ROM 220 is a memory that stores a program required for starting the device for determining configuration of sites 100, and the like.

The auxiliary storage device 230 is a device such as an HDD (Hard Disk Drive) and the like for example. It may be an SSD (Solid State Drive) using a flush memory and the like, The display device 240 is a device such as a CRT display, LCD (Liquid Crystal Display), organic EL (Electro-Luminescence) display and the like for example.

The input device 250 is a device such as a keyboard, mouse, microphone and the like for example. The medium reading device 260 is a device for reading the information of a portable storage medium having portability such as a CD-ROM and the like. The communication device 270 inputs/outputs data from/to external devices through a network 280.

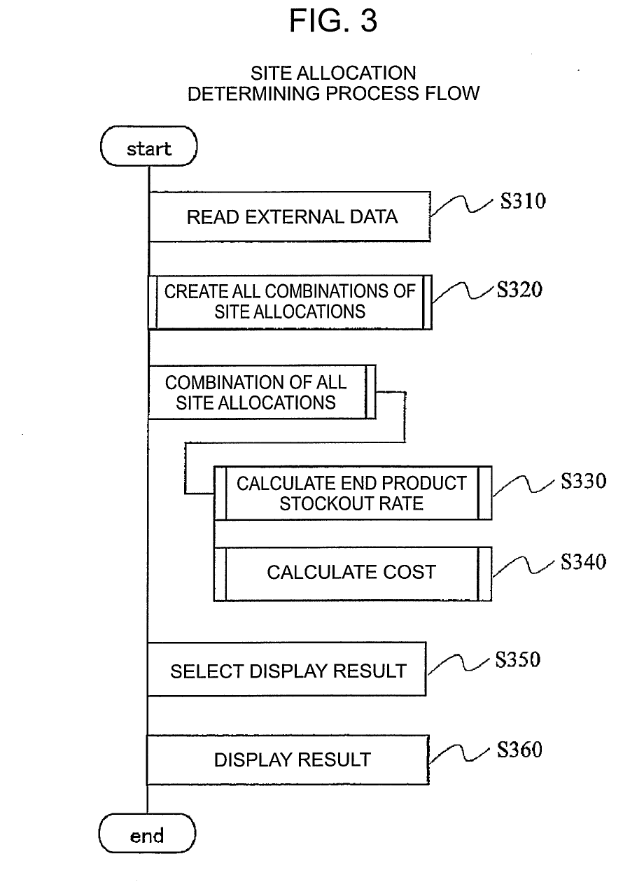

FIG. 3 is an example of the site allocation determining process flow explaining the process of the site allocation determining device 100. In the site allocation determining process, (1) an external data reading process 310, (2) an all combination creating process 320 of the site allocation, (3) an end product stockout rate calculating process 330 for combination of all site allocations, (4) a cost calculating process 340 for combination of all site allocations, (5) a display result selecting process 350, and (6) a result displaying process 360 are executed.

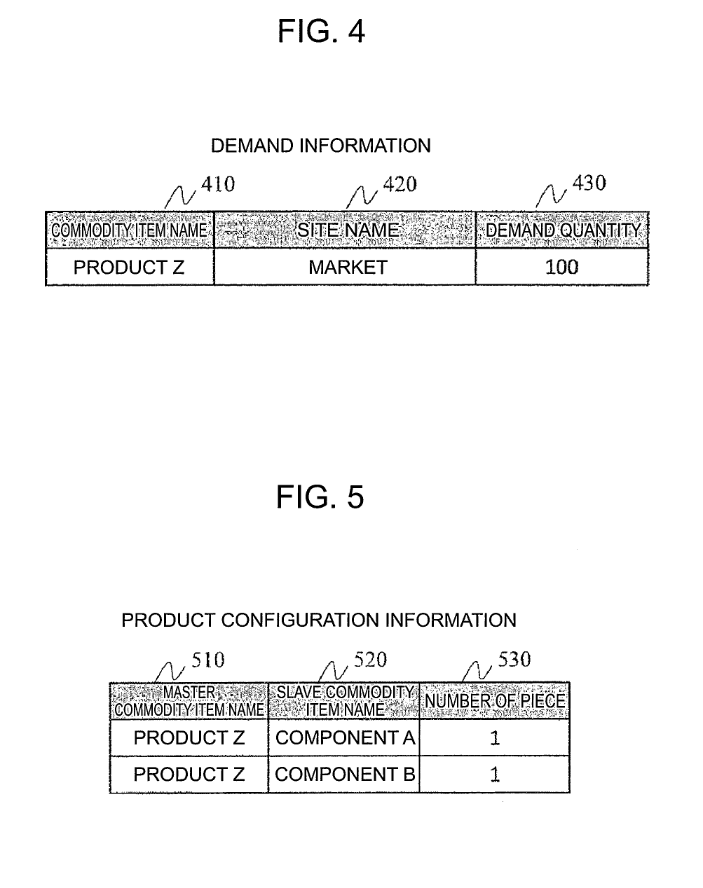

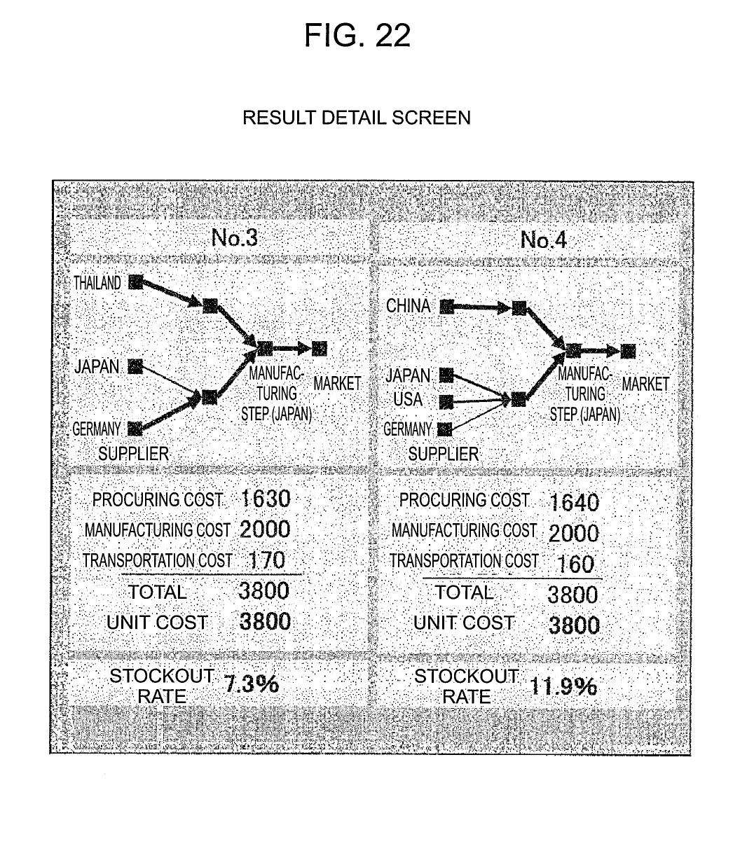

Below, each of the processes (1)-(6) of FIG. 3 will be described referring to FIG. 4-FIG 22.

### (1) External Data Reading Process

In (1) the external data reading process 310 of FIG. 3, the demand information, product configuration information, site information, distribution information, cost information, trouble probability information, and result comparison standard information which are the external data are read.

In the external data reading process 310, the data acquired from the input unit 110 of FIG. 1 are stored in the storage unit 120. More specifically, operation of the input device 250 of FIG. 2 by a site allocation determining person is received, and the external data are acquired from the medium reading device 260 or the communication device 270 and are stored in the auxiliary storage device 230.

FIG. 4 is an example of demand information 400. The demand information 400 at least includes data items that define commodity item name 410, site name 420, and demand quantity 430.

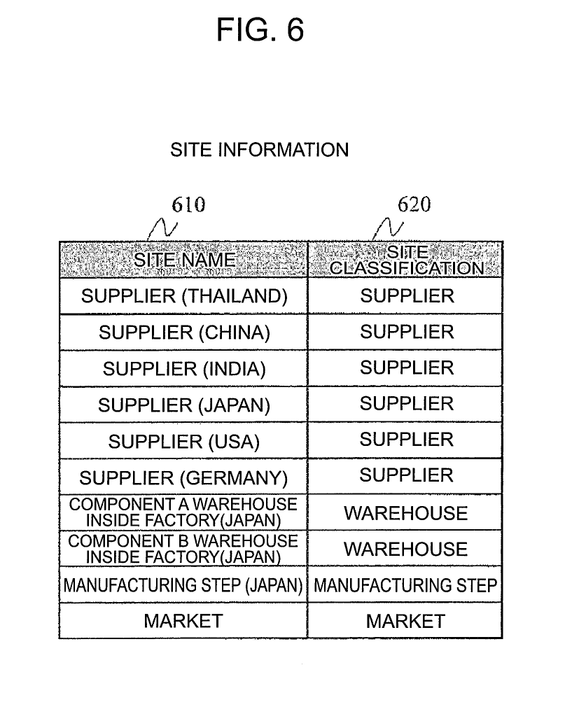

FIG. 5 is an example of product configuration information 500. The product configuration information 500 at lest includes data items that define master commodity item name 510, the master commodity item being a product produced, slave commodity item name 520, the slave commodity item being an origin for creating the master commodity item, and configuration number 530 that expresses the quantity of the slave commodity items required for creating one unit of the master commodity item. FIG. 6 is an example of site information 600. The site information 600 at least includes data items that define site name 610, and site classification 620. Also, the site classification is the classification watching the process in the site, and defines at least four kinds of “supplier” that becomes the uppermost stream of the site allocation, “market” that becomes the lowermost stream of the site allocation, “warehouse” in which the commodity item entering the site and the commodity item exiting from the site are identical, and “manufacturing step” in which the commodity item entering the site and the commodity item exiting from the site are different from each other.

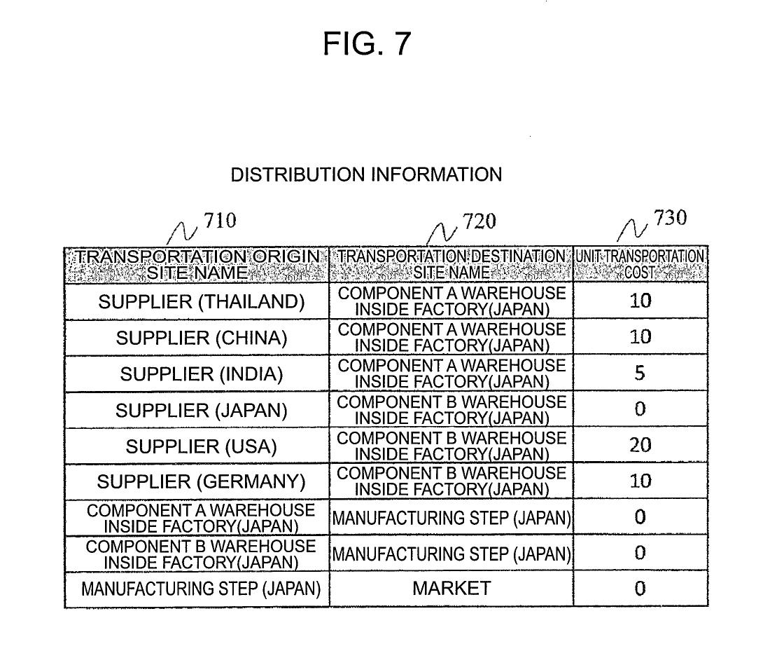

FIG. 7 is an example of distribution information 700. The distribution information 700 at least includes data items that define names of the sites that become transmission origins 710, names of the sites that become transmission destinations 720, and unit transportation cost in transporting one unit of the commodity item from the transmission origin to the transmission destination 730.

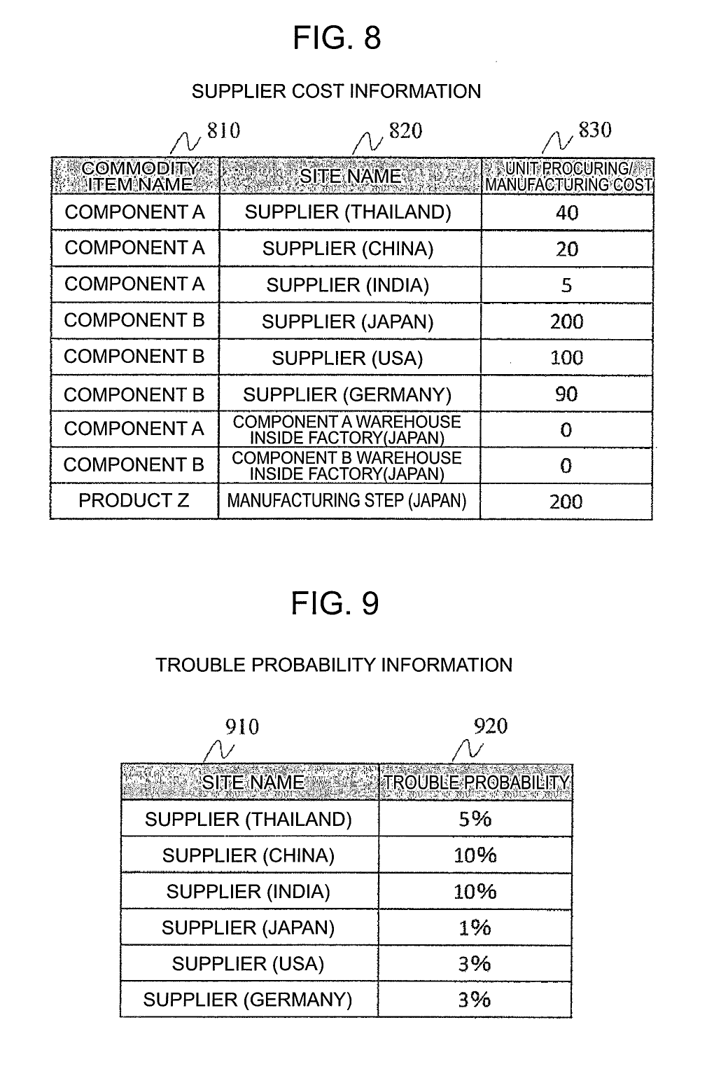

FIG. 8 is an example of supplier cost information 800. The supplier cost information 800 at least includes data items that define commodity item name 810, site name 820, and unit procuring/manufacturing cost 830 generated in procuring/manufacturing one unit of the commodity item at the site.

FIG. 9 is an example of trouble probability information 900. The trouble probability information 900 at least includes data items that define site name 910, and probability of trouble at site 920.

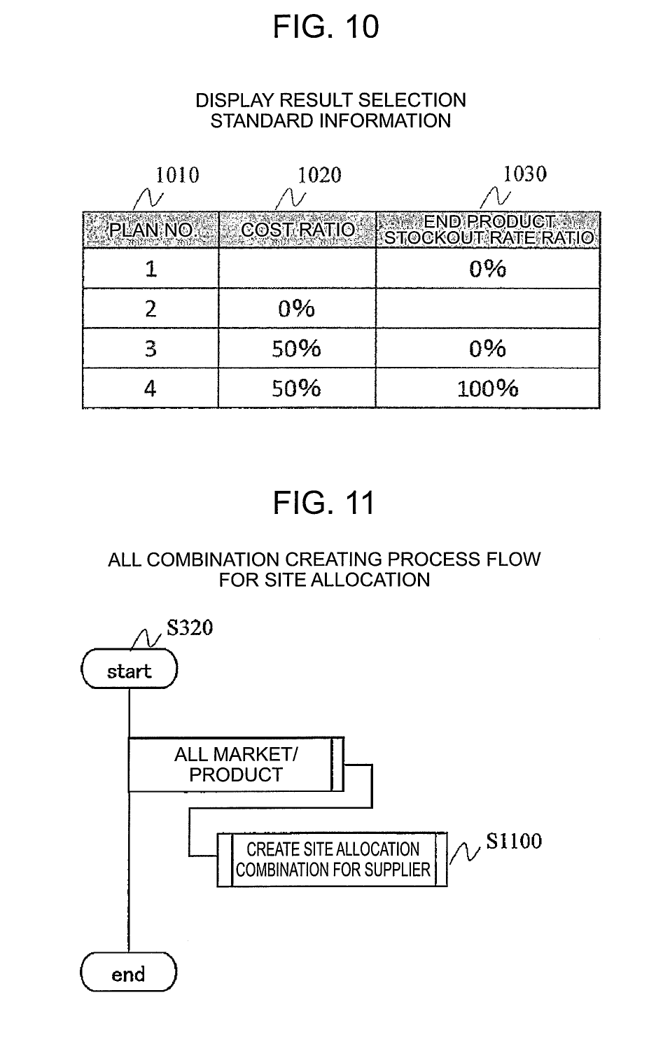

FIG. 10 is an example of display result selection standard information 1000. The display result selection standard information 1000 at least includes data items that define No. of site allocation plan displayed 1010, ratio of cost of site allocation plan displayed to the best cost 1020, and ratio of end product stockout rate of site allocation plan displayed to the best value 1030. Also, instead of the ratio of site allocation plan displayed to the best cost, the value of the target cost may be inputted. Further, instead of the ratio of site allocation plan displayed to the best end product stockout rate, the target value of the stockout rate of the end product may be inputted.

When acquisition of the external data of FIG. 4-FIG 10 as described above finishes, (2) all combination creating process for site allocation starts.

### (2) All Combination Creating Process for Site Allocation

In (2) the all combination creating process for site allocation 320 of FIG. 3, as shown in the flow of FIG. 11, a site allocation combination creating process for supplier 1100 is executed for all combinations of the market/product.

The all combination creating process for site allocation 320 is executed by the end product stockout rate and cost evaluation unit 130 utilizing the data of the storage unit 120 of FIG. 1. More specifically, the CPU 201 loads the program stored in the ROM 220 of FIG. 2, the data of the auxiliary storage device 230 are read out to the RAM 210, the process is executed, and the result is stored in the auxiliary storage device 230.

FIG. 11 is an all combination creating process flow for site allocation. In the all combination creating process for distribution route 320, a site allocation combination creating process for suppliers 1100 is executed for all combinations of the market/product.

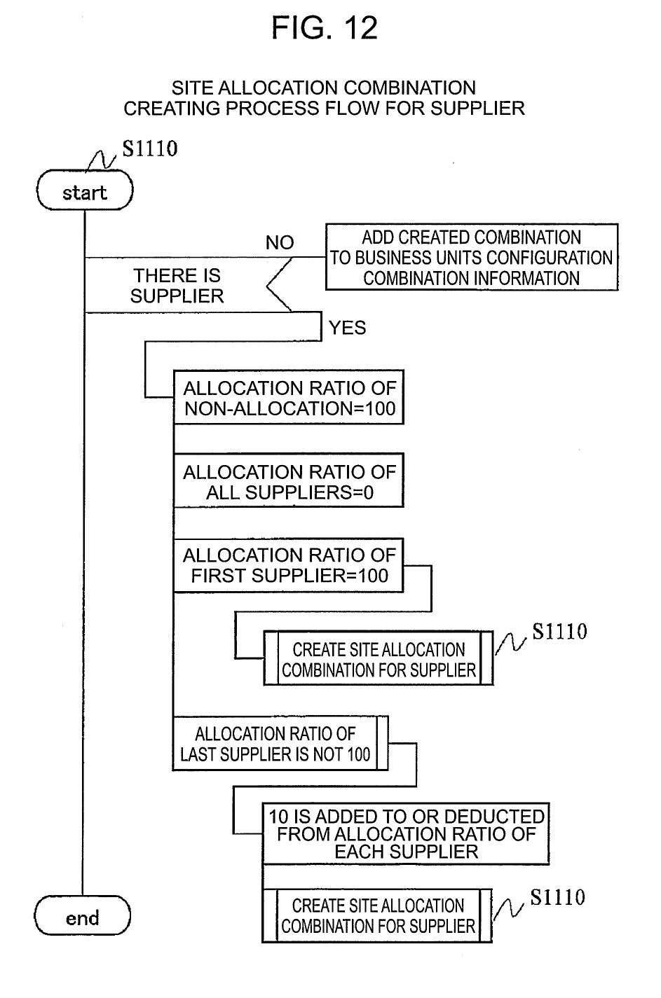

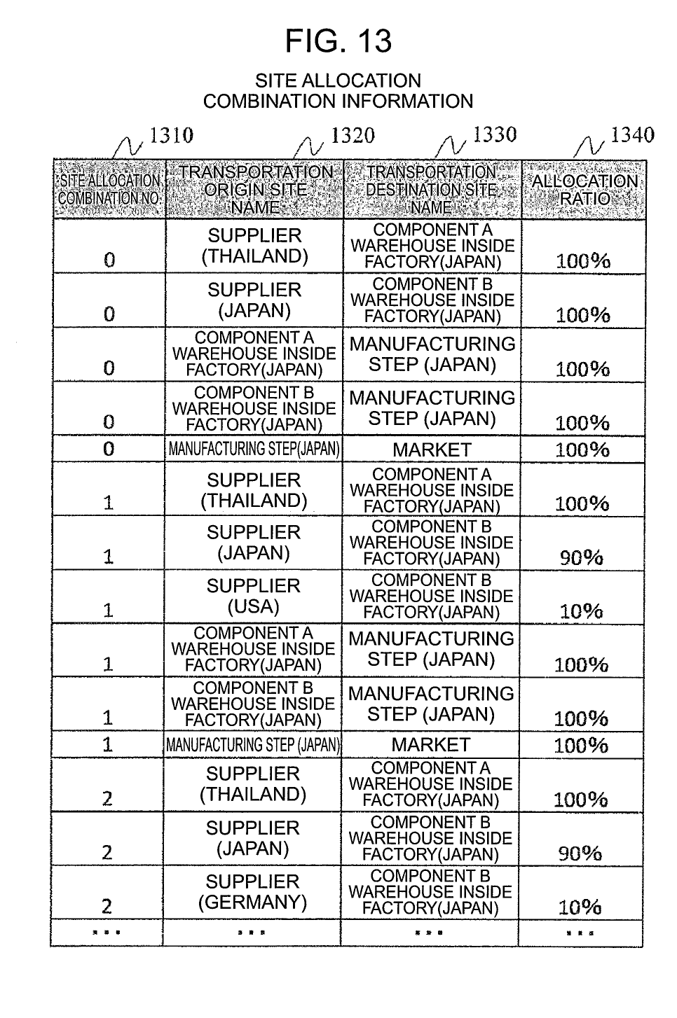

Below, the site allocation combination creating process for supplier 1100 will be described referring to FIGS. 12-13.

FIG. 12 is a process flow of the site allocation combination creating process for supplier 1100 which is a process executed for all combinations of the market/product in FIG. 11. When there is no supplier of the site/commodity item in question, the site allocation combination creating process for supplier 1100 finishes with the combinations created so far being added to the site allocation combination information. When there is a supplier of the site/commodity item in question, 10 is added to or deducted from the allocation ratio of the supplier, a new combination of site allocation is thereby created, the site allocation combination creating process for supplier 1100 is recursively called, and thereby the site allocation combination information of FIG. 13 is outputted.

FIG. 13 is an example of site allocation combination information 1300. The site allocation combination information 1300 at least includes data items that define site allocation combination No. 1310, transportation origin site name 1320, transportation destination site name 1330, and an allocation ratio 1340 that is the ratio of the quantity supplied from the transportation origin site to the required quantity at the transportation destination site.

### (3) End Product Stockout Rate Calculating Process for Combination of All Site Allocations

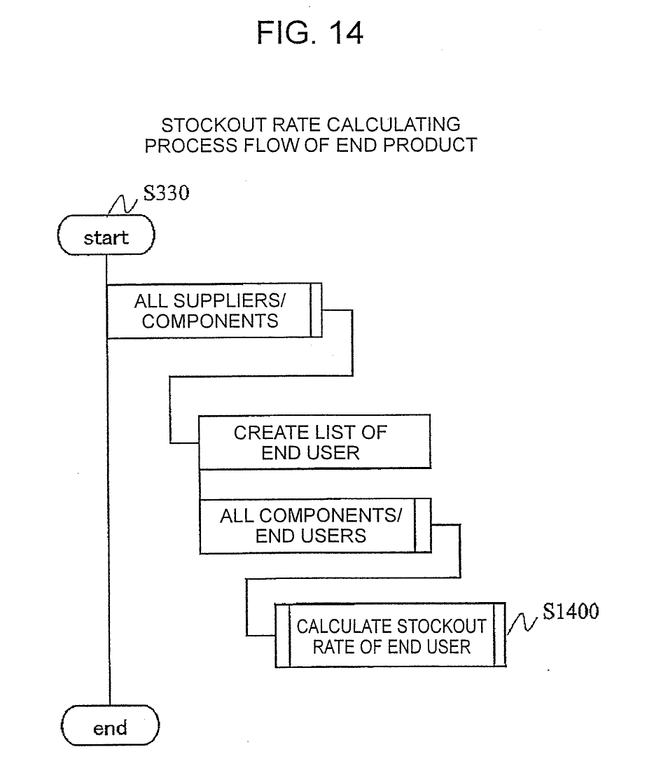

In (3) the end product stockout rate calculation 330 of FIG. 3, as shown in the flow of FIG. 14, stockout rate of end user calculating process k is executed for all combinations of the supplier/component. The end product stockout rate calculating process 330 is executed by the end product stockout rate and cost evaluation unit 130 utilizing the data of the storage unit 120 of FIG. 1. More specifically, the CPU 201 loads the program stored in the ROM 220 of FIG. 2, the data of the auxiliary storage device 230 are read out to the RAM 210, the process is executed, and the result is stored in the auxiliary storage device 230.

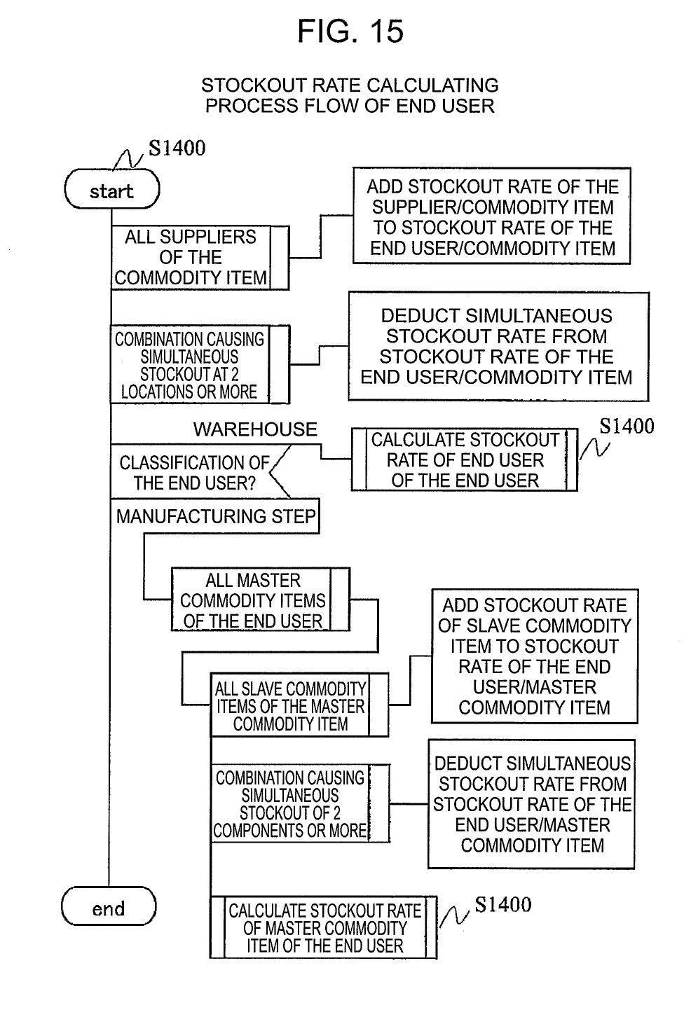

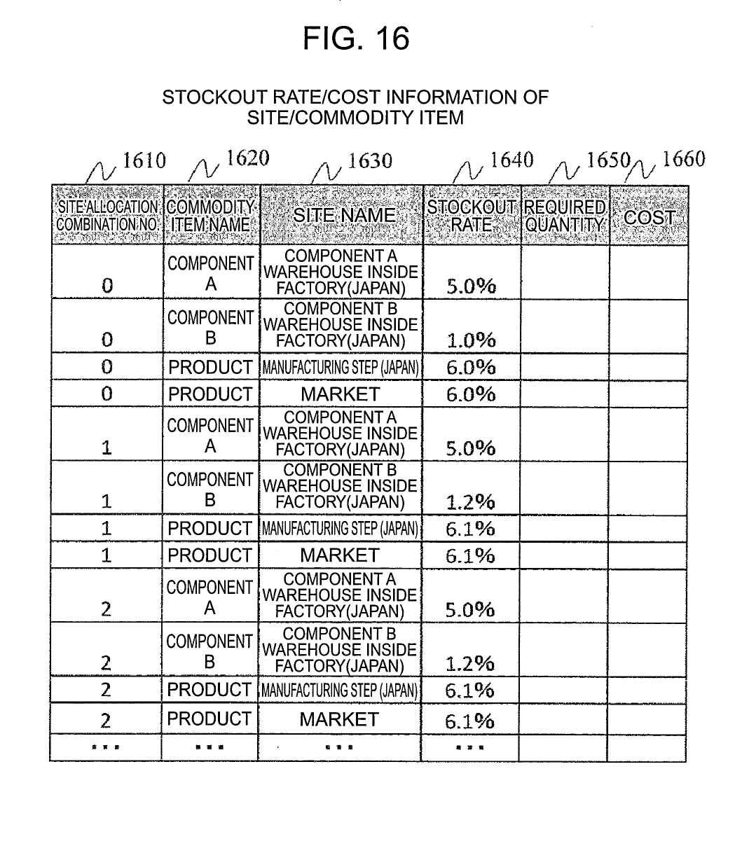

FIG. 14 is an end product stockout rate calculating process flow. In the end product stockout rate calculating process 330, for all combinations of the supplier/component, a list of the sites that become the end user thereof is created, and for all combinations of the end user site/component, stockout rate of end user calculating process 1400 is executed. Below, the stockout rate of end user calculating process 1400 will be described referring to FIGS. 15-16.

FIG. 15 is a process flow of the stockout rate of the end user calculating process 1400 that is a process executed for all combinations of the supplier/component in FIG. 14, In the stockout rate of end user calculating process 1400, first, the stockout rate is calculated for all suppliers of the site/commodity item in question by the following expressions and are added.

Stockout rate of supplier/commodity item=stockout rate of supplier/commodity item×allocation ratio of supplier/commodity item
Stockout rate of end user/commodity item=stockout rate of end user/commodity item+stockout rate of supplier/commodity item

Next, all combinations of 2 locations, 3 locations . . . n locations (n is the number of all suppliers) are created from all suppliers of the site/commodity item in question, and, with respect to these combinations, such probability that the stockout occurs simultaneously at selected suppliers is obtained from the expression below and is deducted from the stockout rate.

Probability of simultaneous stockout=Π(stockout rate of selected supplier×allocation ratio)
Stockout rate of end user/commodity item=stockout rate of end user/commodity item-probability of simultaneous stockout

Further, the trouble probability at the end user is added, and such probability that the trouble at the end user and the stockout at the supplier simultaneously occur is deducted.

Stockout rate of end user/commodity item=stockout rate of end user/commodity item+trouble probability at end user×(1-probability of simultaneous stockout)

When the classification of the site in question is the warehouse, with respect to the end user of the end user, the stockout rate of end user calculating process 1400 is recursively called. When the classification of the site in question is the manufacturing step, the stockout rate of the master commodity item is calculated using the calculated stockout rate of the site/commodity item in question.

The stockout rate of the maser commodity item is obtained by the following procedure. First, the stockout rates of all of the slave commodity items of the site in question are added up. Stockout rate of end user/master commodity item=Σ(stockout rate of end user/slave commodity item)

Next, such combination as causing simultaneous stockout of two components or more is created, and the probability of simultaneous stockout is deducted from the stockout rate of the end user/master commodity item in question. The probability of simultaneous stockout is obtained from the following expression.

Probability of simultaneous stockout=Π(stockout rate of selected slave commodity item)
Stockout rate of end user/master commodity item=stockout rate of end user/master commodity item-probability of simultaneous stockout

After the stockout rate of the master commodity item is obtained, with respect to the end user of the mster commodity item, the stockout rate of end user calculating process 1400 is recursively called. By repeating the procedure described above, the stockout rate/cost information of the site/commodity item of FIG. 16 is outputted. FIG. 16 is an example of the stockout rate/cost information of site/commodity item 1600. The stockout rate/cost information of site/commodity item 1600 at least includes data items that define site allocation combination No. 1610, commodity item name 1620, site name 1630, stockout rate of site/commodity item 1640, required quantity of site/commodity item 1650, and cost generated at site/commodity item 1660. In the stockout rate of end user calculating process 1400, the site allocation combination No., commodity item name, site name, and stockout rate are outputted.

### (4) Cost Calculating Process

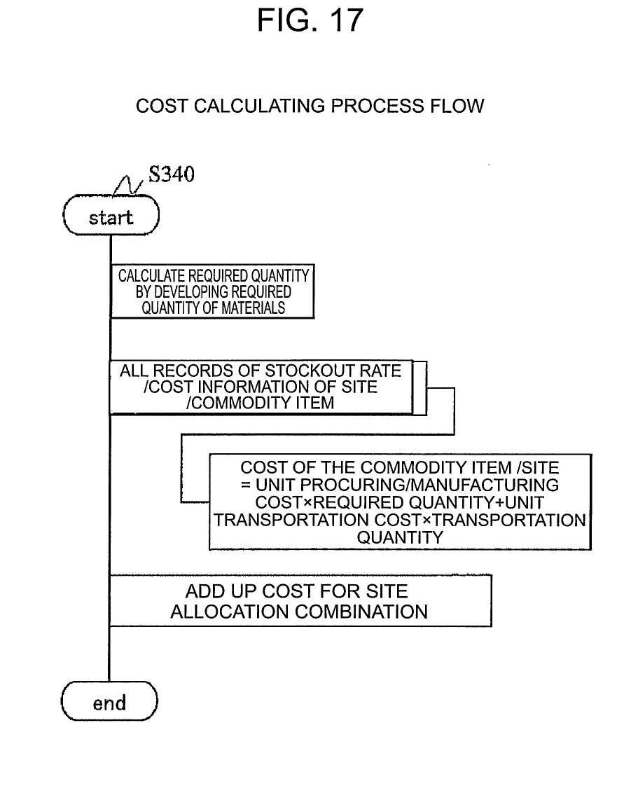

In (4) the cost calculating process 340 of FIG. 13, as shown in the flow of FIG. 17, after executing development of the required quantity of materials, the cost is calculated with respect to all records of the stockout rate/cost information of site/commodity item 1600.

The cost calculating process 340 is executed by the end product stockout rate and cost evaluation unit 130 utilizing the data in the storage unit 120 of FIG. 1. More specifically, the CPU 201 loads the program stored in the ROM 220 of FIG. 2, the data of the auxiliary storage device 230 are read out to the RAM 210, the process is executed, and the result is stored in the auxiliary storage device 230.

FIG. 17 is a cost calculating process flow. In the cost calculating process 340, first, the required quantity of each site/commodity item and the transportation quantity from the transportation origin to the transportation destination are calculated based on the demand information and are outputted to the required quantity of stockout rate/cost information of site/commodity item 1650. Calculation of the required quantity employs a general method for calculating required quantity of materials.

Next, with respect to all records of the stockout rate/cost information of the site/commodity item, the cost of the site/commodity item in question is calculated by the following expression, and the cost of stockout rate/cost information of site/commodity item 1660 is outputted.

Cost of site and commodity item=unit procuring and manufacturing cost×required quantity+Σ_{transportation origin} (unit transportation cost×transportation quantity) [MATH.1]

All records of the stockout rate/cost information of the site/commodity item are added for each site allocation combination No., and the stockout rate and cost information of the end product is outputted. The cost per one end product is obtained by the following expression.

Cost per one site and commodity item=cost of site and commodity item/demand quantity

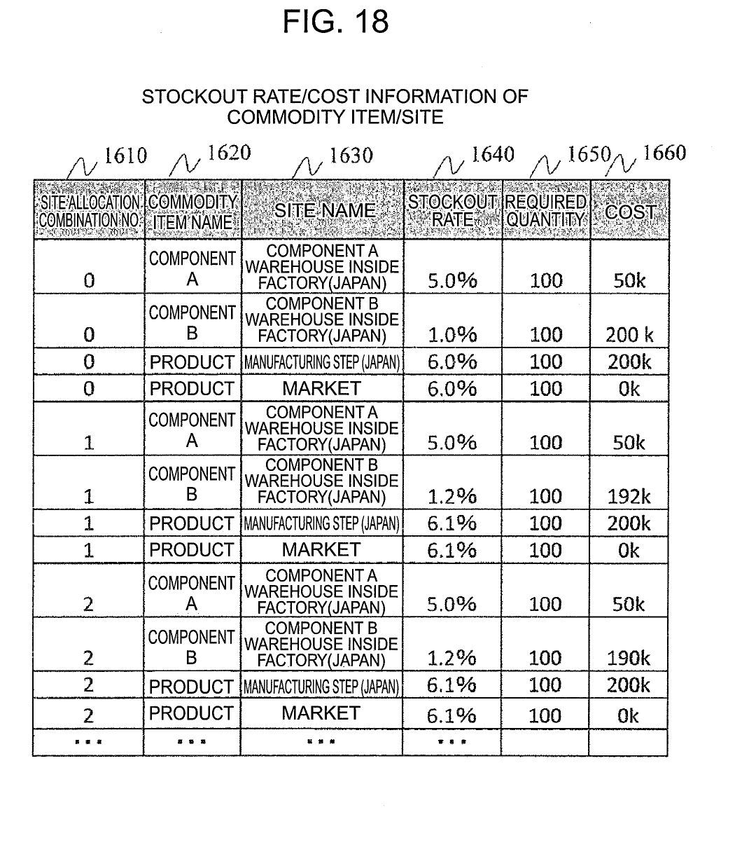

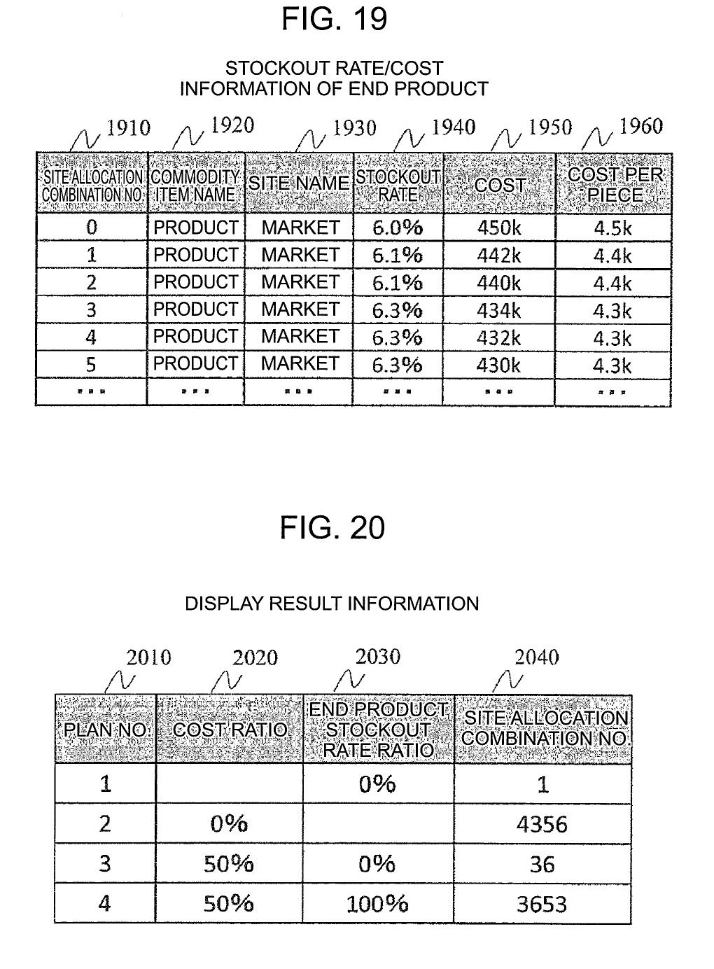

FIG. 18 is an example of outputting the required quantity 1650 and the cost 1660 of the stockout rate/cost information of site/commodity item 1600. FIG. 19 is an example of stockout rate/cost information of end product 1900. The stockout rate/cost information of end product 1900 at least includes data items that define site allocation combination No. 1910, commodity item name 1920, site name 1930, stockout rate of end product 1940, cost incurred for production of end product 1950, and cost converted to one piece of end product 1960.

(5) Display result selecting process

In (5) the display result selecting process 350 of FIG. 3, the record corresponding to the display result selection standard information 1000 is selected from the stockout rate/cost information of end product 1900. When the cost ratio of the display result selection standard information 1000 is 0%, the record whose cost is lowest is selected from the stockout rate/cost information of end product 1900. When the end product stockout rate ratio of the display result selection standard information 1000 is 0%, the record whose end product stockout rate is lowest is selected from the stockout rate/cost information of end product 1900, and the display result information of FIG. 20 is outputted. Also, when there exist plural combinations of commodity item/site for one site allocation combination, average values are adopted for the stockout rate and the cost per piece, and the process described above is executed with the average values being taken as the stockout rate and the cost per piece of the site allocation combination.

The display result selecting process 350 is executed by the end product stockout rate and cost evaluation unit 130 utilizing the data of the storage unit 120 of FIG. 1. More specifically, the CPU 201 loads the program stored in the ROM 220 of FIG. 2, the data of the auxiliary storage device 230 are read out to the RAM 210, the process is executed, and the result is stored in the auxiliary storage device 230.

FIG. 20 is an example of display result information 2000. In the display result information 2000, at least a plan No. 2010, cost ratio 2020, end product stockout rate ratio 2030, and site allocation combination No. 2040 are defined.

### (6) Result Displaying Process

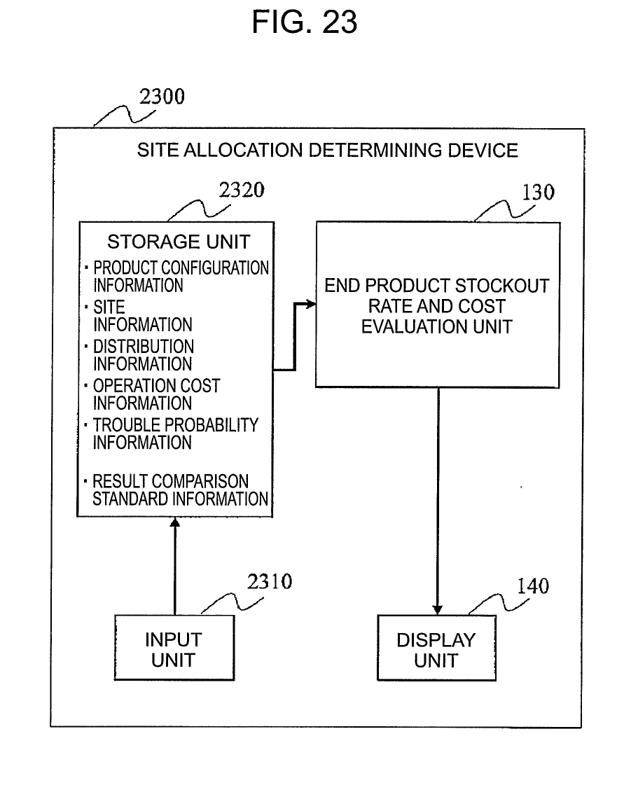

In (6) the result displaying selecting process 350 of FIG. 3, a result display screen shown in FIG. 23 is displayed.

The result display is displayed on a display unit 150 of FIG. 1. More specifically, the CPU 201 loads the program stored in the ROM 220 of FIG. 2, and the data of the auxiliary storage device 230 are read out to the RAM 210 and are outputted to the display device 240. Also, operation of the input device 250 by a site allocation determining person is received, the CPU 201 loads the program stored in the ROM 220 based on the information, the data of the auxiliary storage device 230 are read out to the A I. 210, and the output of the display device 240 is changed. Further, when the result display finishes, the information stored in the auxiliary storage device 230 are saved.

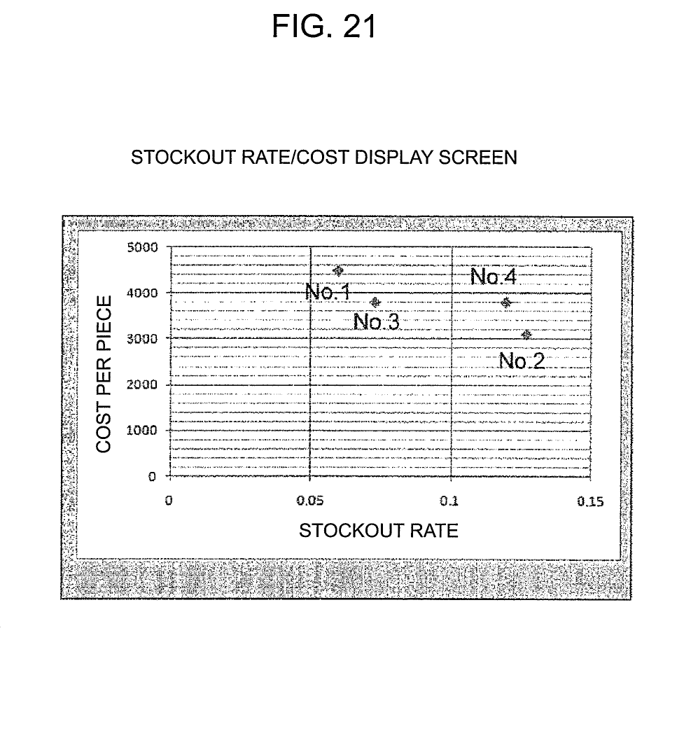

FIG. 21 is an example of a stockout rate/cost display screen 2100. The stockout rate/cost display screen 2100 displays the stockout rate and the cost per piece with the stockout rate/cost information of the end product of FIG. 19 and the display result information of FIG. 20 being inputted.

For example, in FIG. 21, the axis of abscissa represents the stockout rate, the axis of ordinates represents the cost per piece, and the site allocation is displayed as a plot. The plot is preferable to be in the left below of the drawing. It is known that, although the stockout rate of the end product can be suppressed to approximately 6% at the minimum, the cost the cost per piece becomes 450 or more. On the other hand, it is known that the stockout rate of the end product becomes approximately 13% when the cost per piece is suppressed to approximately 300. It is known that, in order to suppress the cost to approximately an average of the minimum and the maximum and to suppress the stockout rate, the site allocation of the plan No. 3 is suitable.

FIG. 22 is an example of a result detail screen 2200. The result detail screen 2200 displays the supply route of the commodity item, cost breakdown (procuring cost, manufacturing cost, transportation cost), unit cost per piece, and the stockout rate of the end product with the stockout rate/cost information of the commodity item/site of FIG. 18, the stockout rate/cost information of the end product of FIG. 19, and the display result information of FIG. 20 being inputted.

For example, in FIG. 22, although the procuring cost is same with respect to the plan No. 3 and the plan No. 4, the breakdown thereof is different from each other. In the plan No. 3, the stockout rate is suppressed by purchasing all of the component A from Thailand where the trouble probability is low, and the procurement cost is suppressed by increasing the purchase of the component B from Germany where the cost is inexpensive. On the other hand, in the plan No. 4, because all of the component A is purchased from China where the trouble probability is high, the procuring cost is inexpensive, however the stockout rate is high.

Accordingly, by employing the site allocation of the plan No. 3, the stockout rate can be suppressed at an approximately same cost.

### EXAMPLE 2

In the present example, a site allocation determining device in which inputting of the trouble probability is simplified will be described. FIG. 23 is an example of the block diagram showing the function configuration of the site allocation determining device of the present example.

A site allocation determining device 2300 includes an input unit 2310, a storage unit 2320, the end product stockout rate and cost evaluation unit 130, and the display unit 140. The end product stockout rate and cost evaluation unit 130 and the display unit 140 are similar to those of the example 1.

The input unit 2310 reads the demand information, product configuration information, site information, distribution information, cost information, trouble probability information, and result comparison standard information which are the external data, and stores the same in the storage unit 2320. In storing the site information, residence area 2430 of each record of site information 2400 is made a key, a record that agrees to an area 2510 of trouble probability information 2500 is retrieved, and trouble probability 2520 of the trouble probability information 2500 of the record is outputted to trouble probability 2440 of the record of the site information 2400.

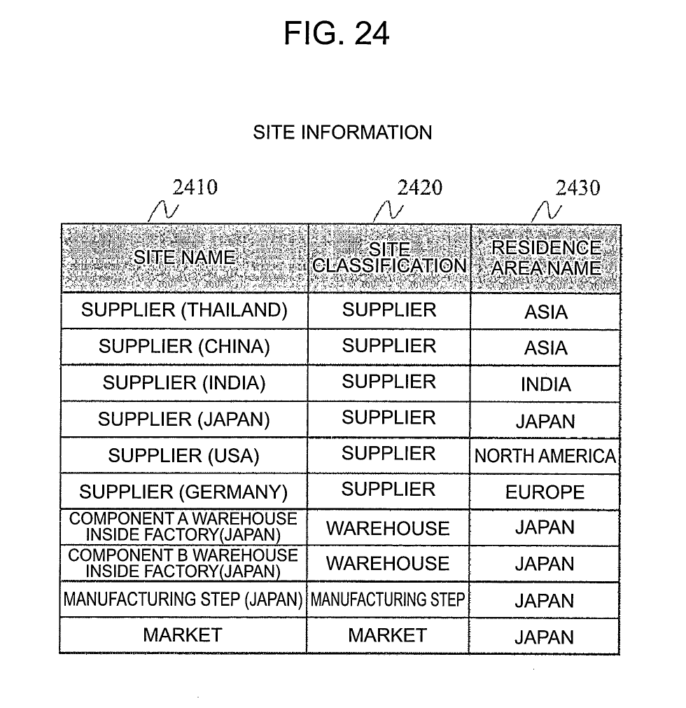

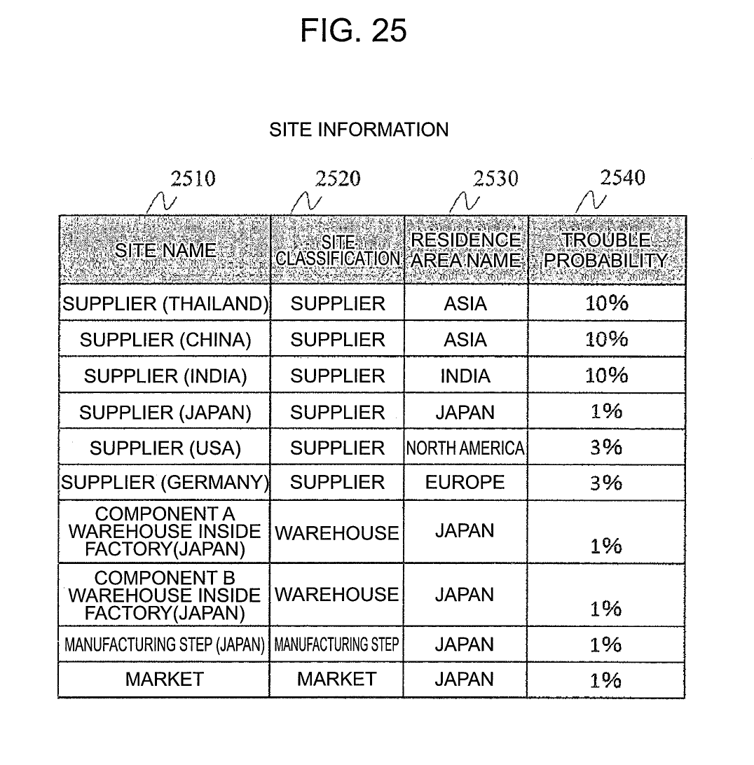

The storage unit 2320 stores the demand information, product configuration information, site information, suppliers information, distribution information, operation cost information, trouble probability information, and result comparison standard information which are the external data. FIG. 24 is an example of the site information 2400. The site information 2400 at least includes data items that define site name 2410, site classification 2420, and residence area 2430. Also, an example of the site information 2400 stored in the storage unit 2320 with the trouble probability being added by the input unit 2310 is FIG. 25. Data items that define trouble probability 2540 are added to data items of the site information 2400 of FIG. 24.

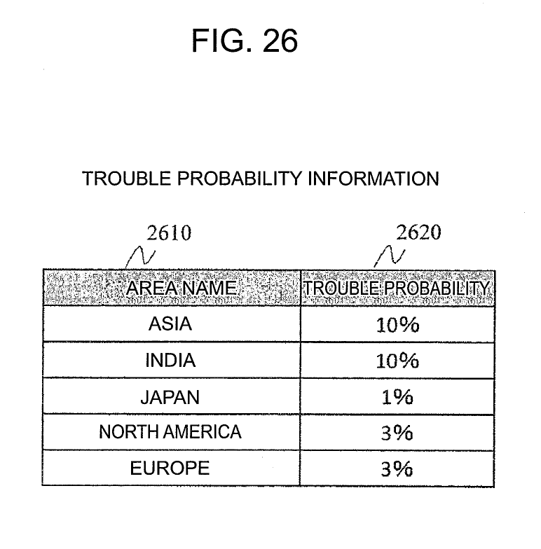

FIG. 26 is an example of trouble probability information 2600. The trouble probability information 2610 at least includes data items that define area name 2610 and trouble probability 2620.

Also, the present invention is not limited to the examples described above, and various alterations are included therein. For example, the examples described above were described in detail for easy understanding of the present invention, and the present invention is not necessarily limited to those having all configurations described. Further, a part of a configuration of an example can be replaced by a configuration of another example, and also, to a configuration of an example, a. configuration of another example can be added. Furthermore, a part of a configuration of each example can be subjected to adding, deleting and replacing of another configuration.

Also, with respect to each of the configurations, functions, processing units, processing means and the like described above, a part or all thereof may be achieved by hardware such as designing by an integrated circuit for example. Further, each of the configurations, functions and the like described above may be achieved by software by that a processor interprets and executes a program that achieves each of the functions. Information such as the program, table, file and the like achieving each of the functions can be placed in a recording device such as a memory, hard disk, SSD (Solid State Drive) and the like, or in a storage medium such as an IC card, SD card, DVD and the like.

Furthermore, with respect to the control line and information line, those supposed to be necessary for explanation are shown, and all of the control lines and information lines in the product are not necessarily shown. It is right thinking that almost all configurations are connected to each other in actual fact.

### REFERENCE SIGNS LIST

100 . . . site allocation determining device in example 1, 110 . . . input unit, 120 . . . storage unit, 130 . . . end product stockout rate and cost evaluation unit, 140 . . . display unit, 201 . . . CPU, 210 . . . RAM, 220 . . . ROM, 230 . . . auxiliary storage device, 240 . . . display device, 250 . . . input device, 260 . . . medium reading device, 270 . . . communication device, 280 . . . network, S310 . . . external data reading process, S320 . . . all combination creating process of site allocation, S330 . . . end product stockout rate calculating process, S340 . . . cost calculating process, S350 . . . display result selecting process, S360 . . . result display 410 . . . commodity item name, 420 . . . site name, 430 . . . demand quantity, 510 . . . master commodity item name, 520 . . . slave commodity item name, 530 . . . number of piece, 610 . . . site name, 620 . . . site classification, 710 . . . transportation origin site name, 720 . . . transportation destination site name, 810 . . . commodity item name, 820 . . . site name, 830 . . . procuring/manufacturing unit cost, 910 . . . site name, 920 . . . trouble probability, 1010 . . . plan No., 1020 . . . cost ratio, 1030 . . . end product stockout rate ratio, S1100 . . . site allocation combination creating process for supplier, 1310 . . . site allocation combination No., 1320 . . . transportation origin site name, 1330 . . . transportation destination site name, 1340 . . . allocation ratio, S1400 . . . stockout rate of end user calculating process, 1610 . . . site allocation combination No., 1620 . . . commodity item name, 1630 . . . site name, 1640 . . . stockout rate, 1650 . . . required quantity, 1660 . . . cost, 1910 . . . site allocation combination No., 1920 . . . commodity item name, 1930 . . . site name, 1940 . . . stockout rate, 1950 . . . cost, 1960 . . . cost per piece, 2010 . . . displayed plan number, 2020 . . . cost ratio, 2030 . . . end product stockout rate ratio, 2040 . . . sites combination No. 2300 . . . site allocation determining device in example 2, 2310 . . . input unit in example 2, 2320 . . . storage unit in example 2, 2410 . . . site name, 2420 . . . site classification, 2430 . . . residence area name, 2510 . . . site name, 2520 . . . site classification, 2530 . . . residence area name, 2540 . . . trouble probability 2610 . . . area name, 2620 . . . trouble probability

1. A device for determining configuration of sites producing the stockout rate and cost of end products by accumulating the stockout rate and cost of commodity items for upstream sites in each of the sites on a distribution network, comprising:
a storage unit for storing demand information including demand quantity, product configuration information expressing the relation between master commodity items and slave commodity items constituting products, site information including names and classification information of the sites, transportation information including information pertaining to supply routes between the sites, cost information including the cost generated by procurement and manufacture of products and commodity items, and trouble probability information including the probability of trouble occurring at each of the sites; and
a stockout rate and cost evaluation unit for setting the lowermost stream of the site information as a starting point, creating a plurality of combinations for the configuration of the sites while varying the allocation ratio of the supply routes included in the transportation information, setting a commodity item in the site constituting the uppermost stream in the site information as a starting point for each of created combinations for the configuration of the sites, tracing end users in accordance with the supply routes included in the transportation information, calculating the stockout rate of each of the commodity items for each of the sites from the trouble probability information, and calculating the stockout rate and cost of the end products by calculating the cost of each of the commodity items for each of the sites from the cost information and accumulating the results.

2. The device for determining configuration of sites according to claim 1, wherein
the storage unit stores display result standard information that defines a selection standard of an output result by specifying the cost and/or stockout rate, and
the stockout rate and cost evaluation unit outputs a combination for the configuration of the sites which agrees to the display result standard information out of information of each of the combinations for the configuration of the sites calculated.

3. The device for determining configuration of sites according to claim 1, wherein
the stockout rate and cost evaluation unit makes a display unit comparatively display the stockout rate and the cost of an end product in a plurality of combinations for the configuration of the sites.

4. The device for determining configuration of sites according to claim 1, wherein
the stockout rate and cost evaluation unit makes a display unit comparatively display a site diagram that connects a site and a site to each other, a cost breakdown, and a stockout rate of an end product with respect to a plurality of combinations for the configuration of the sites.

5. The device for determining configuration of sites according to claim 1, wherein
in the storage unit, an area to which a site belongs is defined in the site information, and the trouble probability information includes data items that define trouble probability for each area.

6. A method for determining configuration of sites used in a device that includes:
a storage unit for storing demand information including demand quantity, product configuration information expressing the relation between master commodity items and slave commodity items constituting products, site information including names and classification information of the sites, transportation information including information pertaining to supply routes between the sites, cost information including the cost generated by procurement and manufacture of products and commodity items, and trouble probability information including the probability of trouble occurring at each of the sites; and
a stockout rate and cost evaluation unit for calculating the stockout rate and cost of end products using information stored in the storage unit, comprising the steps of:
setting the lowermost stream of the site information as a starting point and creating a plurality of combinations for the configuration of the sites while varying the allocation ratio of the supply routes included in the transportation information;
setting a commodity item in the site constituting the uppermost stream in the site information as a starting point for each of the created combinations for the configuration of the sites, tracing end users in accordance with the supply routes included in the transportation information, and calculating the stockout rate of each of the commodity items for each of the sites from the trouble probability information; and
calculating the stockout rate and cost of the end products by calculating the cost of each of the commodity items for each of the sites from the cost information and accumulating the results.

7. The method for determining configuration of sites according to claim 6, wherein
the storage unit stores display result standard information that defines selection standard of an output result by specifying the cost and/or stockout rate, and
a step of outputting a combination for the configuration of the sites which agrees to the display result standard information out of information of each of the combinations for the configuration of the sites calculated is further comprised.

8. The method for determining configuration of sites according to claim 6, further comprising:
a step of making a display unit comparatively display the stockout rate and cost of an end product with respect to a plurality of combinations for the configuration of the sites.

9. The method for determining configuration of sites according to claim 6, further comprising:
a step of making a display unit comparatively display a site diagram that connects a site and a site to each other, a cost breakdown, and the stockout rate of an end product with respect to a plurality of combinations for the configuration of the sites.

10. The method for determining configuration of sites according to claim 6, wherein
in the storage unit, an area to which a site belongs is defined in the site information, and the trouble probability information includes data items that define the trouble probability for each area.
